(19) United States
(12) Patent Application Publication
(10) Pub. No.: US 2026/0328939 A1
(43) Pub. Date: Oct. 22, 2026

(54) ULTRASONIC SENSOR FOR A MOTOR VEHICLE, MOTOR VEHICLE, AND METHOD FOR PRODUCING AN ULTRASONIC SENSOR

(71) Applicant: VALEO SCHALTER UND SENSOREN GMBH, Bietigheim-Bissingen (DE)

(72) Inventors: Philipp Maurer, Bietigheim-Bissingen (DE); Paul Bou Saleh, Bietigheim-Bissingen (DE); Raffi Kalayciyan, Bietigheim-Bissingen (DE); Fabian Haag, Bietigheim-Bissingen (DE); Bastian Hafner, Bietigheim-Bissingen (DE)

(73) Assignee: VALEO SCHALTER UND SENSOREN GMBH, Bietigheim-Bissingen (DE)

(21) Appl. No.: 19/116,881

(22) PCT Filed: Sep. 21, 2023
(86) PCT No.: PCT/EP2023/075992

§ 371 Date: Mar. 28, 2025

(30) Foreign Application Priority Data
Sep. 28, 2022 (DE) 10 2022 124 937.9

(51) Int. Cl. G01S 15/931; G01S 7/521

(52) U.S. Cl. CPC G01S 15/931; G01S 7/521; G01S 2015/937

(57) ABSTRACT

An ultrasonic sensor for a motor vehicle includes a plastics housing; a diaphragm cup that is inserted into an opening in the plastics housing and has an ultrasonic diaphragm; a sound transducer element for inducing and sensing vibration of the ultrasonic diaphragm, which sound transducer element is mounted on the ultrasonic diaphragm from the inside; a circuit board which is disposed in the interior of the plastics housing and on which a driver circuit for controlling the sound transducer element is mounted; two contact pins for bringing the driver circuit into electrical contact with the sound transducer element, the circuit board is pressed onto the contact pins such that ends of the contact pins pass through the circuit board; and a metal hood which, together with the circuit board, surrounds and shields on all sides the ends of the contact pins passing through the circuit board.

The present invention relates to an ultrasonic sensor for a motor vehicle and to a motor vehicle.

Modern motor vehicles are equipped with ultrasonic sensors which allow an environment of the motor vehicle to be measured by transmitting and receiving an ultrasonic signal. The information obtained in this way regarding the environment of the vehicle can be evaluated by a driver assistance system, in order to generate warnings for the driver, and to enable autonomous parking or partially or fully autonomous driving.

An ultrasonic sensor typically has a plastics housing with an opening into which a membrane pot is inserted. A sound transducer element for inducing and sensing vibration of the ultrasound membrane is arranged on an ultrasound membrane of the membrane pot from the inside. Furthermore, a printed circuit board is arranged in the interior of the plastics housing, on which printed circuit board a driver circuit for activating the sound transducer element is mounted. Contact pins are used to contact the driver circuit with the sound transducer element. In particular, unamplified signals on the conduction path from the sound transducer element by way of the contact pins to the driver circuit are particularly susceptible to electromagnetic interference.

A shielding plate was conventionally arranged on an upper side (a side facing away from the sound transducer element) of the printed circuit board to shield against electromagnetic interference, which shielding plate covered substantially the entire printed circuit board or at least the entire area of the components of the driver circuit which were mounted on the lower side of the printed circuit board, for example. The entire arrangement was then cast with a synthetic resin.

However, it is desirable to dispense with the casting, since this causes up to 20 g of additional weight which alters the stress properties of the ultrasonic sensor and thereby increases the risk of component parts breaking. Without casting, it is not possible to securely mount a large-area shielding plate arranged freely then in the interior of the plastics housing. The shielding plate would be set into vibration under the influence of the ultrasound and become dislodged. This is why the shielding plate is also dispensed with, and reliance is placed on downstream signal processing and the maintaining of minimum distances during installation in order to circumvent electromagnetic interference.

In certain installation situations, such as in bumpers of a motor vehicle, however, the EMC interference resistance is still not satisfactory.

WO 2017/097496 discloses that a membrane of a sound transducer element can be connected to a ground.

US 2019/0388936 A1 discloses a membrane pot for an ultrasonic transducer. The membrane pot is provided with a metallic coating. A piezoelectric element fitted on the membrane from the inside is electrically connected to the metallic coating. The membrane pot accordingly implements an electrical functionality, in particular an electrical ground for improving EMC protection.

US 2006/0229785 A1 discloses a pedestrian protection system in which a plurality of ceramic sensors is attached to a carrier film. The carrier film has a continuous metallization layer or metallic protective layer for EMC shielding of the plurality of ceramic sensors.

Against this background, an object of the present invention is to improve the EMC interference resistance of an ultrasonic sensor.

According to a first aspect, to achieve the object, an ultrasonic sensor for a motor vehicle is proposed, which has: a plastics housing, a membrane pot that is inserted into an opening of the plastics housing and has an ultrasound membrane, a sound transducer element for inducing and sensing vibration of the ultrasound membrane, which sound transducer element is fitted on the ultrasound membrane from the inside, a printed circuit board arranged in the interior of the plastics housing, on which printed circuit board a driver circuit for activating the sound transducer element is mounted, two contact pins for electrically contacting the driver circuit with the sound transducer element, wherein the printed circuit board is pressed onto the contact pins in such a way that ends of the contact pins pass through the printed circuit board, and a metallic hood which, together with the printed circuit board, surrounds and shields on all sides the ends of the contact pins passing through the printed circuit board.

The inventors have realized that the contact pins passing through the printed circuit board play a decisive role as antennas for electrical interference. However, pressing the printed circuit board onto the ends of the contact pins in such a way that they penetrate the printed circuit board is desirable and advantageous, because in this case a simple production method and a more stable and higher-quality connection between the contact pins and the printed circuit board can be achieved compared to a case in which the contact pins are soldered to the printed circuit board only from one side. According to the proposed ultrasonic sensor, the contact pins passing through the printed circuit board are now shielded by the metallic hood. Therefore, a field entry of an electrical field can advantageously be dissipated before it can couple into the capacitance formed by the contact pins extending substantially parallel to one another. Accordingly, the interference resistance of the ultrasonic sensor against electrical fields can advantageously be improved. Therefore, there is also no damage caused when the contact pins form a high capacitance. It is therefore now possible to arrange the contact pins very closely beside one another. An inductance formed by the contact pins can thus advantageously be kept low. Accordingly, the interference resistance of the ultrasonic sensor against magnetic fields can also advantageously be improved. Overall, the EMC interference resistance of the ultrasonic sensor can therefore advantageously be improved.

The membrane pot with ultrasound membrane can be formed in one piece. That is to say, the membrane pot can be an element in the form of a pot. A bottom face of the pot form can be made to be thinner than walls of the pot form. In this case, the bottom face in particular forms the ultrasound membrane.

The contact pins can be pressed into the plastics housing and can thereby be fitted securely against vibration in the housing. The pressing-in of the contact pins into the plastics housing can take place before the printed circuit board is pressed onto the ends of the contact pins.

The contact pins can be contacted with the driver circuit, for example, by the fact that the ends of the contact pins, when the printed circuit board is pressed onto the ends of the contact pins, are pressed into a through-plating, also known as a via, with a metallized, for example tin-plated, inner face. Accordingly, a reliable electrical contacting of the contact pins with the driver circuit can be provided.

The sound transducer element is a piezoelectric element, for example. The activation of the sound transducer element comprises in particular sending an activation signal to the sound transducer element and then receiving a received signal from the sound transducer element.

That end of a respective contact pin which passes through the printed circuit board can also be referred to as the “upper end”. At a lower end opposite the upper end, the contact pins can be contacted directly with the sound transducer element, for example soldered to it. The contact pins can also be contacted indirectly with the sound transducer element. For example, a loose fine wire can be used to connect a lower end of a respective one of the contact pins to the sound transducer element. A region between the sound transducer element and the lower end of the contact pin, in which the loose fine wire extends, can be backfilled with a foam. Accordingly, an additional sound decoupling can be achieved.

“Surround on all sides together with the printed circuit board” is understood to mean in particular that a space in which the upper ends of the contact pins are arranged is delimited in each spatial direction either by an area of the metallic hood or by an area of the printed circuit board.

The metallic hood is in particular a grounded metallic hood. “Grounded” is understood in particular to mean an at least not high-impedance connection to a ground. “Not high-impedance” is understood in particular to mean a resistance to ground of less than 1000 ohms, preferably less than 800 ohms, particularly preferably less than 600 ohms.

According to one embodiment, the driver circuit comprises one or more electronic components which are mounted outside the metallic hood on the printed circuit board on the same side of the printed circuit board as the metallic hood.

The components are arranged outside the metallic hood and are accordingly not shielded by it. However, the metallic hood shields the ends of the contact pins at which electrical interference fields are most likely to couple in. The metallic hood is therefore advantageously small and can be mounted securely against vibration on the printed circuit board. Advantageously, therefore, it is possible to dispense with casting the interior of the plastics housing.

The side of the printed circuit board on which the metallic hood, the ends of the contact pins passing through the printed circuit board and, according to the present embodiment, also the electronic components are arranged, can also be referred to as the upper side. The other side of the printed circuit board, on which the remaining portions of the contact pins are arranged and contact the sound transducer element, can also be referred to as the lower side.

The electronic components can include a capacitor, a coil, a transistor, an operational amplifier, a processor, an ASIC and the like, for example.

According to a further embodiment, an interior in the plastics housing is not cast at least on the same side of the printed circuit board as the metallic hood.

The interior can be in particular an open space, that is to say a non-backfilled space, on the upper side of the printed circuit board insofar as it is not occupied by the metallic hood or the components.

Accordingly, the weight of the ultrasonic sensor can be reduced, the ultrasonic sensor can be less rigid and advantageously there will probably be fewer material breaks. At the same time, however, the metallic hood provides excellent attenuation of electrical fields.

According to a further embodiment, the printed circuit board is fitted upright on a protrusion of the plastics housing.

The upright fitting on the protrusion of the housing advantageously offers stability and vibration resistance.

The protrusion of the plastics housing is in particular an inwardly projecting protrusion. The protrusion can be annular or circumferential. The protrusion can in particular be formed in the vicinity of the membrane pot, where a main portion of the plastics housing narrows to the opening into which the membrane pot is inserted. An upright fitting on such a protrusion can in particular be made possible only by the fact that the components are advantageously arranged on the upper side of the printed circuit board. This in turn can be made possible in particular by the fact that the metallic hood provides shielding against electrical interference fields, which shielding could not previously be provided using conventional solutions in the case of components arranged on the upper side.

According to a further embodiment, the metallic hood has four walls that extend perpendicular to the printed circuit board and a wall that extends parallel to the printed circuit board and over the ends of the contact pins.

In other words, the metallic hood is in particular a cuboid or cube-shaped hood. Advantageously, such a hood can be produced particularly easily. Additionally, it can be fastened securely against vibration on the printed circuit board particularly advantageously at three edges at which it stands upright on the printed circuit board and can advantageously be very rigid.

According to a further embodiment, an outer wall of the metallic hood is arranged at a border of the printed circuit board, and a tab formed continuously with the outer wall extends past the border of the printed circuit board toward the membrane pot.

Advantageously, therefore, a portion of the contact pins on the lower side of the printed circuit board between the printed circuit board and the membrane pot can also be shielded by the tab and the shielding action can be further improved. “Arranged at a border” can mean in particular that the outer wall is arranged in such a way that the tab extending from the outer wall toward the membrane pot touches the border of the printed circuit board.

The tab and the outer wall can be formed in particular in one piece. The metallic hood can be formed in one piece as a whole, wherein the tab and the outer wall are portions of the one-piece metallic hood. The outer wall can be one of the walls that extend perpendicular to the printed circuit board.

The tab extends at least in a direction toward the membrane pot. Particularly preferably, the tab advantageously extends as far as the membrane pot or as far as level with the membrane pot.

According to a further embodiment, the tab extends parallel to a plane formed by the two contact pins and is as wide as or wider than a distance between the two contact pins.

Therefore, a capacitance formed by the two contact pins, in a portion of the contact pins which extends along the tab, is advantageously shielded by the tab.

According to a further embodiment, the metallic hood is contacted with the printed circuit board and grounded.

Accordingly, grounding of the metallic hood can advantageously be provided by way of a conductor track of the printed circuit board. The printed circuit board can, in addition to the two contact pins which are used to contact the sound transducer element, be pressed onto further contact pins which connect the interior of the plastics housing to an exterior of the plastics housing. In this way, a vehicle ground for grounding the metallic hood can be led into the ultrasonic sensor and to the metallic hood.

According to a further embodiment, the metallic hood is contacted with the printed circuit board by means of a spring pin formed continuously with one of the walls of the metallic hood, which spring pin is pressed into a through-plating of the printed circuit board.

Accordingly, it is advantageously possible to press the metallic hood in a particularly simple manner into the through-platings of the printed circuit board when the ultrasonic sensor is assembled, following which the spring pin assumes a stable fit on account of the restoring force after the pressing-in. Therefore, the entire metallic hood can advantageously be mounted on the printed circuit board in a simple, vibration-resistant and stable manner.

Preferably, more than one wall of the metallic hood is provided with a respective spring pin; particularly preferably, at least three of the four walls that extend perpendicular to the printed circuit board, which stand upright on the printed circuit board, are provided with a respective spring pin.

The spring pin can be formed in particular in one piece with the metallic hood.

The through-plating can also be referred to as a contact hole or a via. It can in particular have a metallized, for example tin-plated, inner face which is connected to ground and is in contact with the spring pin if the latter is pressed into the through-plating.

According to a further embodiment, the spring pin is formed as an eyelet that encloses an elongate hole.

Accordingly, the spring pin can be formed particularly simply in one piece with the rest of the metal hood, for example by punching from a metallic sheet.

According to a further embodiment, the metallic hood is produced from copper or brass sheet with a sheet thickness between 0.2 and 0.4 mm, preferably 0.3 mm.

Accordingly, electrical eddy currents with a frequency in the working range of the ultrasonic sensor are attenuated optimally and simultaneously with the minimum necessary material outlay. Therefore, a penetration depth of an electrical eddy current with a frequency of 50 kHz in copper is approximately 0.3 mm.

According to a further embodiment, the metallic hood is punched in one piece from the copper or brass sheet and folded.

Accordingly, a simple and inexpensive production method is possible.

According to a further embodiment, the membrane pot is a metallic membrane pot which is not connected to ground with high impedance.

Accordingly, the membrane pot is grounded and can advantageously also have a shielding action against electromagnetic interference fields. In a particularly preferred embodiment, in which the metallic hood also has the tab which extends as far as the membrane pot, an entire current path of the not-yet-amplified raw signals of the sound transducer element from the metallic element by way of the contact pins as far as the driver circuit can thus be shielded against electrical interference fields by means of the interaction of metallic membrane pot, metallic hood and the walls thereof and the tab thereof.

The membrane pot can be produced from aluminum, for example. As an alternative to this, the membrane pot can be produced from a non-metallic material and can have at least one metallic coating; such a membrane pot can also be considered to be a metallic membrane pot within the meaning of the present embodiment.

“Grounded” is understood in particular to mean an at least not high-impedance connection to a ground. “Not high-impedance” is understood in particular to mean a resistance to ground of less than 1000 ohms, preferably less than 800 ohms, particularly preferably less than 600 ohms.

According to a further aspect, a motor vehicle with an ultrasonic sensor according to the first aspect or one of the embodiments of the first aspect is proposed.

The motor vehicle can be an automobile or a passenger car or a truck, for example.

According to a third aspect, a method for producing an ultrasonic sensor is specified. The method comprises: pressing two contact pins into a plastics housing; inserting a membrane pot with an ultrasound membrane and a sound transducer element for inducing and sensing vibration of the ultrasound membrane, which sound transducer element is fitted on the ultrasound membrane from the inside, into an opening of the plastics housing; contacting the contact pins with the sound transducer element; pressing a printed circuit board, on which a driver circuit for activating the sound transducer element is mounted, onto ends of the contact pins in such a way that the ends pass through the printed circuit board; producing a metallic hood by punching out a blank from a copper or metal sheet and folding the blank; and mounting the metallic hood onto the printed circuit board in such a way that the metallic hood, together with the printed circuit board, surrounds and shields on all sides the ends of the contact pins passing through the printed circuit board.

The embodiments and features described for the proposed ultrasonic sensor apply correspondingly to the proposed motor vehicle and the proposed production method.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention are the subject of the dependent claims and of the exemplary embodiments of the invention that are described below. The invention is explained in more detail below on the basis of preferred embodiments with reference to the accompanying figures.

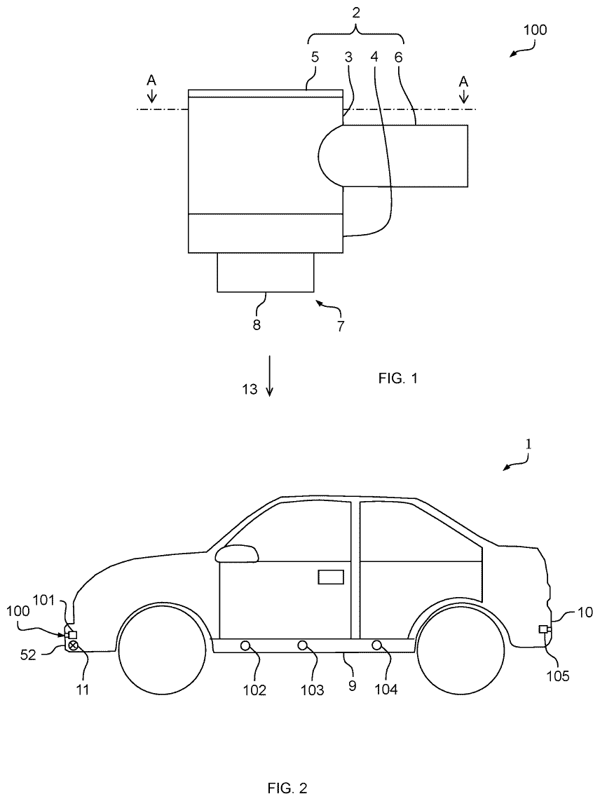

FIG. 1 shows an ultrasonic sensor according to exemplary embodiments;

FIG. 2 shows a motor vehicle according to exemplary embodiments;

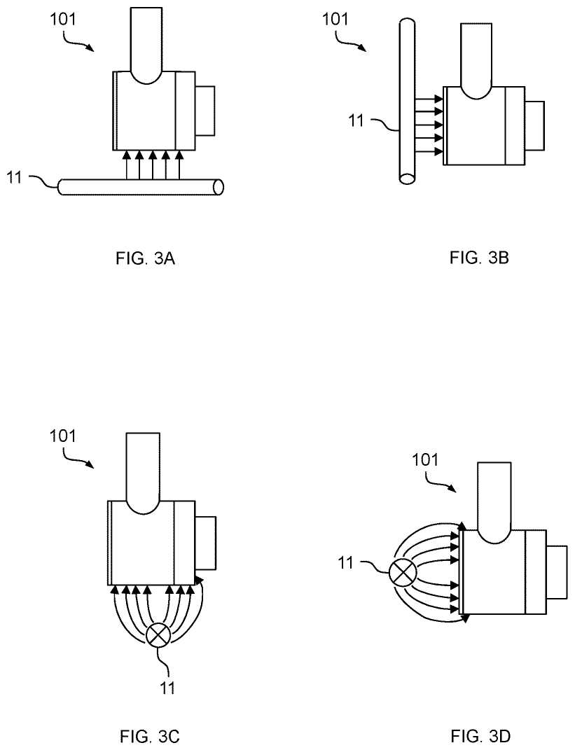

FIGS. 3A-D show possible electrical interference fields;

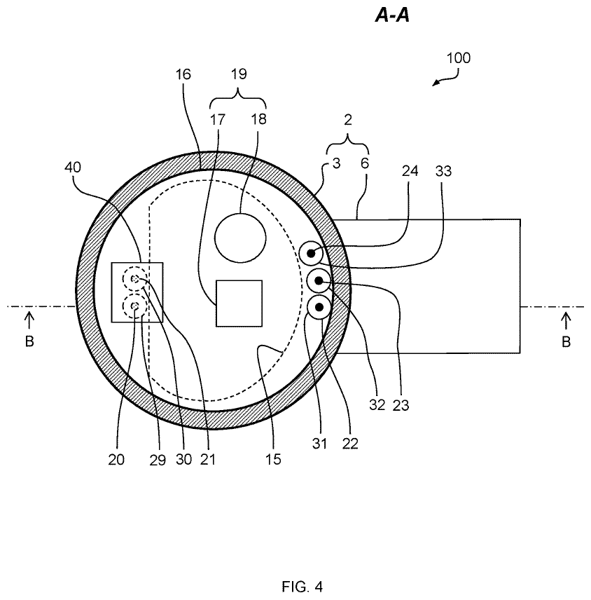

FIG. 4 shows a section A-A in FIG. 1 of an ultrasonic sensor according to a first exemplary embodiment;

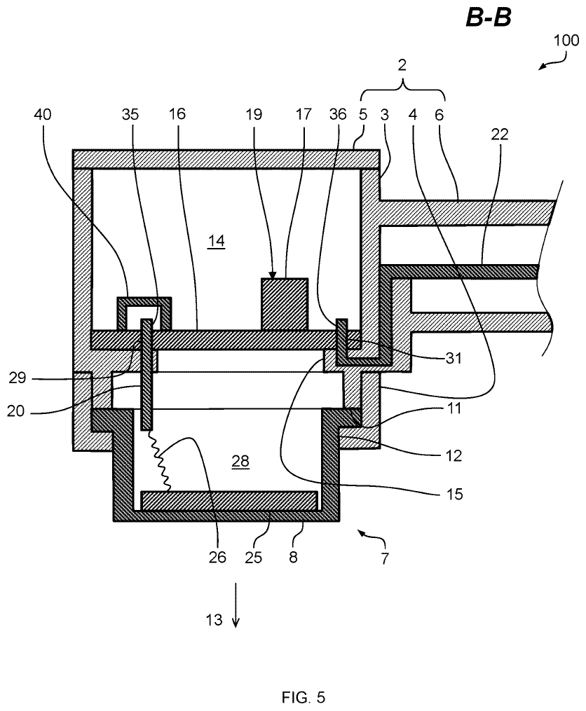

FIG. 5 shows a section B-B in FIG. 4;

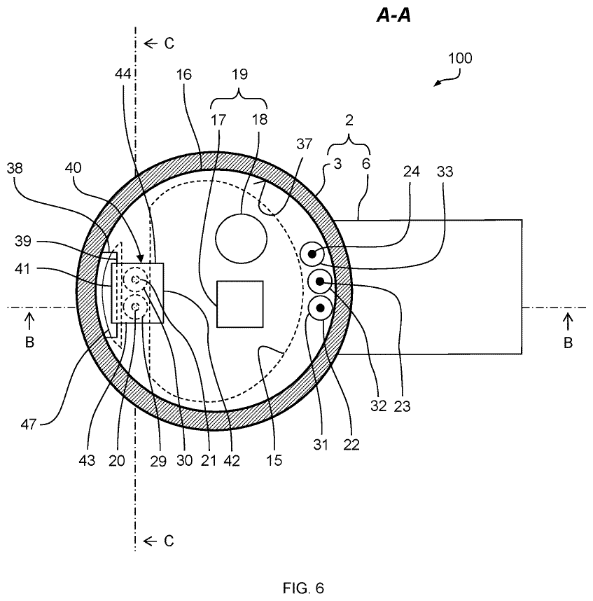

FIG. 6 shows a section A-A in FIG. 1 of an ultrasonic sensor according to a second exemplary embodiment;

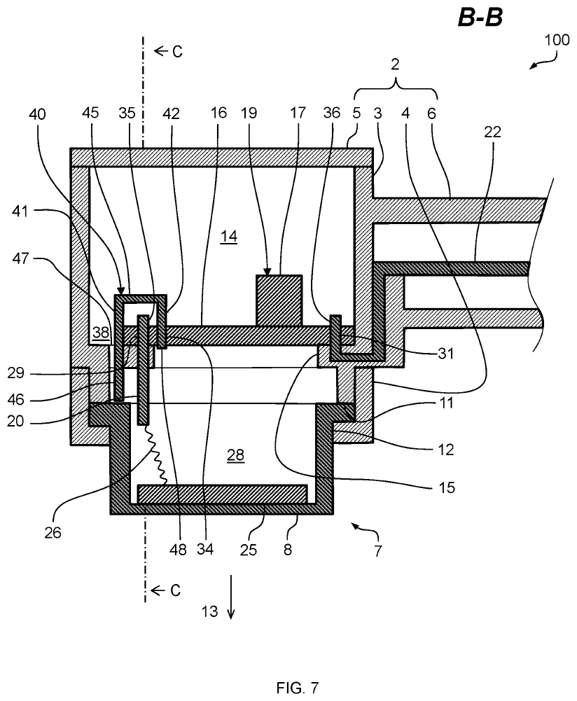

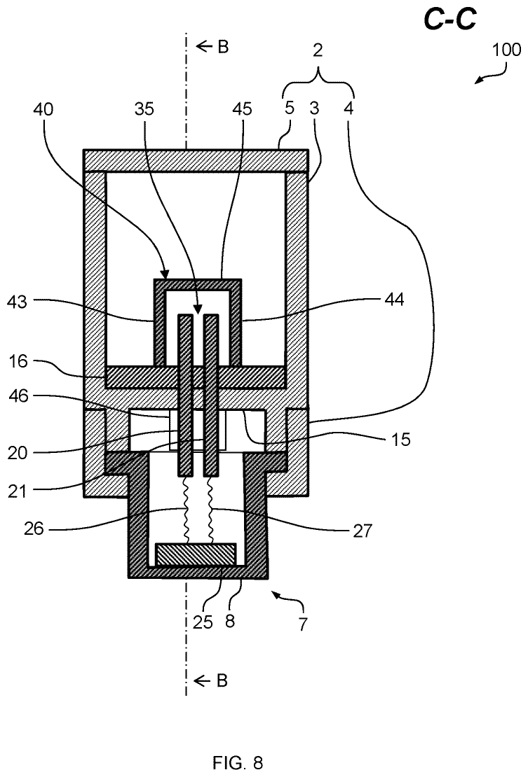

FIG. 7 shows a section B-B in FIGS. 6 and 8;

FIG. 8 shows a section C-C in FIGS. 6 and 7;

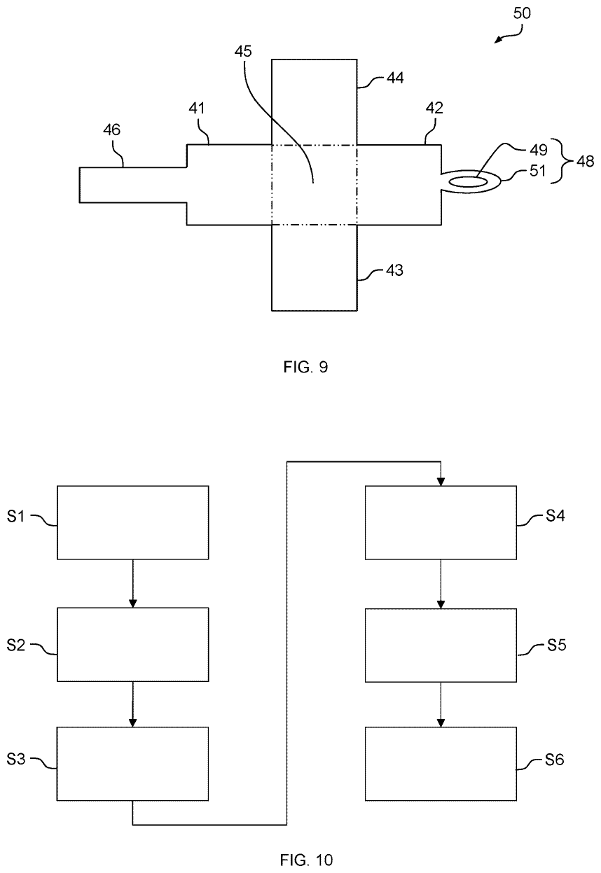

FIG. 9 shows a blank according to the second exemplary embodiment; and

FIG. 10 shows a production method according to a third exemplary embodiment.

Identical or functionally identical elements have been provided with the same reference signs in the figures, unless stated otherwise.

FIG. 1 shows an ultrasonic sensor 100 according to exemplary embodiments. The ultrasonic sensor has a housing 2 made of plastics and a metallic membrane pot 7, with an ultrasound membrane 8, inserted into an opening (not depicted in FIG. 1) of the housing 2. The housing has a body 3, a retaining ring 4, a cover 5 and an extension portion 6. The retaining ring 4 holds the membrane pot 7 on the body 3 of the housing 2. After the components, which are described in more detail hereinafter, are mounted in an interior of the housing 2, the cover 5 is placed on the body 3. The retaining ring 4, the cover 2 and the extension portion 6 can be joined to the body 3 by ultrasonic welding, for example.

The ultrasonic sensor 100 is designed to transmit ultrasonic signals by activating the ultrasound membrane 8, wherein a central direction of an emitted ultrasonic signal lobe coincides with an axial direction 13 of the membrane pot 7. In this case, the ultrasound membrane 8 is used as a “loudspeaker”. The ultrasonic sensor 100 is furthermore designed to receive ultrasonic signals which are reflected for example from an environment of a motor vehicle 1 (FIG. 2). In this case, the ultrasound membrane 8 is used as a “microphone”. Signals for activating the ultrasound membrane 8 and received signals delivered from the ultrasound membrane 8 are led out of the housing 2 of the ultrasonic sensor 100 through the extension portion 6 by signal lines (which are not depicted).

FIG. 2 shows a motor vehicle 1 according to exemplary embodiments. The motor vehicle 1 has a plurality of ultrasonic sensors 100. A first ultrasonic sensor 101 is arranged in a front bumper 52 of the motor vehicle 1. Three ultrasonic sensors 102, 103, 104 are arranged in a side sill 9 of the motor vehicle 1. An ultrasonic sensor 105 is arranged in a rear bumper 10 of the motor vehicle 1.

Moreover, a line 11 of a Local Instrumentation Network, LIN, is arranged in the front bumper 52 of the motor vehicle 1, for example, in the immediate vicinity of the ultrasonic sensor 101. LIN is a simple standard for data-driven on-board vehicle electrical systems and is used for rain sensors, wiper motors, spray devices and the like, for example. The signals of a LIN are rectangular with a stroke of 12 V and have a slew rate of 2 V/μs. A LIN works at a frequency of 19 kHz. A harmonic oscillation of this is three times as high, i.e. 57 kHz, and therefore in a range in which the ultrasonic sensor 101 also transmits and receives acoustic ultrasonic signals. As explained later with reference to FIG. 4 and FIG. 5, electrical signals are produced within the ultrasonic sensor 101 by a sound transducer element 25 (FIG. 5), which electrical signals correspond to the acoustic ultrasonic signals. Electrical fields produced by the line 11 of the LIN therefore represent potential interference fields for the ultrasonic sensor 101. For example, the ultrasonic sensor 101 could incorrectly signal the reception of an ultrasonic echo, even though in fact only an interference field from a signal on the line 11 has interfered with the ultrasonic sensor 101. This is referred to as “phantom echoes”.

This problem is particularly pronounced in the front bumper 52 of the motor vehicle 1, because it may possibly not be feasible to maintain a required minimum distance here between ultrasonic sensor 101 and line 11 due to limited space.

In FIGS. 3A-D, possible relative spatial arrangements of ultrasonic sensor 101 and line 11 are shown. The trajectory of field lines of an electrical interference field is indicated by arrows. As can be seen in FIGS. 3A-D, the electrical interference field acts on the ultrasonic sensor 101 principally from the left and from above.

FIG. 4 shows a section A-A in FIG. 1 of the ultrasonic sensor 100 in a configuration according to a first exemplary embodiment, and FIG. 5 shows a section B-B in FIG. 4. Reference is made hereinafter to FIG. 4 and FIG. 5. A directional indication “downward/downwardly” and a location indication “at the bottom/below” hereinafter refer to a direction along the axial direction 13 downward in FIG. 5 or into the leaf plane in FIG. 4. A directional indication “upward/upwardly” and a location indication “above” hereinafter refer to a direction counter to the axial direction 13 upward in FIG. 5 or out of the leaf plane in FIG. 4.

As can be seen in FIG. 5, the membrane pot 7 is placed on an edge 11 of the body 3 which is open at the bottom. The retaining ring 4 is placed on the membrane pot 7 and the body 3. Accordingly, the membrane pot 7 is inserted into an opening 12 of the housing 2 formed by body 3 and retaining ring 4.

A printed circuit board 16 is arranged in an interior 14 of the housing 2. Electronic components 17, 18 of a driver circuit 19 are arranged on the printed circuit board 16. The driver circuit 19 can furthermore comprise conductor tracks, not shown, which extend on or in the printed circuit board 16.

A plurality of first contact pins 20, 21 are pressed into the body 3 of the housing 2. Furthermore, a plurality of second contact pins 22, 23, 24 are pressed into the body 3 and the extension portion 5 of the housing 6.

The first contact pins 20, 21 are used to contact the driver circuit 19 with a piezoelectric element 25 arranged on an inner side of the ultrasound membrane 8. Lower ends of the first contact pins 19, 20 are contacted indirectly with the piezoelectric element 25 by way of respective loose fine wires 26 which are not under stress. A lower region 28 of the interior 14 in the region of the loose wires 26 can be backfilled with a foam. Therefore, an advantageous vibration decoupling between the ultrasound membrane 8 with the piezoelectric element 25 on the one hand and the housing 3 and the printed circuit board 16 on the other hand is achieved.

The second contact pins 22, 23, 24 are used to contact the driver circuit 19 with lines (not shown) which lead out of the ultrasonic sensor 100 through the extension portion 6 and are connectable to a control device (not shown) of the motor vehicle 1 (FIG. 2), for example.

The printed circuit board 16 has a plurality of through-platings 29-33. The printed circuit board is pressed onto upper ends 35, 36 of the contact pins 20-24, such that the upper ends 35, 36 of the contact pins 20-24 pass through the through-platings 29-33 of the printed circuit board 16. In this way, the contact pins 20-24 are contacted with the driver circuit 19. At the same time, this provides a tight fit for the printed circuit board 16 on the contact pins 20-24.

In addition, the printed circuit board 16 is particularly preferably fitted upright on a circumferential and inwardly projecting protrusion 15 of the housing 2. Fitting on the protrusion 15 arranged far below therefore makes it possible for the components 17, 18 of the driver circuit 19 to be arranged on the upper side of the printed circuit board 16, that is to say on the same side as the upper ends 35, 36 of the contact pins 20-24 passing through the printed circuit board 16. The printed circuit board 16 is therefore advantageously pressed and fitted stably and securely, in particular securely against vibration, in the housing 2.

In operation, the driver circuit 19 is activated by the control device, not shown, of the motor vehicle 1 (FIG. 2) by way of the contact pins 22, 23, 24 and the lines, not shown. The driver circuit generates a suitable electrical activation signal for the piezoelectric element 25 and transfers it to the piezoelectric element 25 by way of the contact pins 20, 21 and the loose fine wires 26. In response to the activation signal, the piezoelectric element 25 induces vibrations in the ultrasound membrane 8 of the membrane pot 7, as a result of which an acoustic ultrasonic signal is transmitted in the axial direction 13. If this ultrasonic signal is reflected back to the ultrasound membrane 8 in the environment of the motor vehicle 1 (FIG. 2), vibrations are induced in the ultrasound membrane. The piezoelectric element 25 senses the vibrations of the ultrasound membrane 8 and sends an electrical received signal, which is indicative of the received ultrasonic signal, to the driver circuit 19 by way of the loose fine wires 26 and the contact pins 20, 21. The driver circuit 19 amplifies the received signal and sends it to the control device, not shown, of the motor vehicle 1 (FIG. 2) by way of the contact pins 22, 23, 24 and the lines, not shown. The control device, not shown, can use a runtime difference between transmitting the ultrasonic signal and receiving the reflected ultrasonic signal to determine, for example, a distance to an obstacle in an environment of the motor vehicle 1 (FIG. 2).

Here it should be noted that a non-amplified and thus very weak electrical received signal is transferred from the piezoelectric element 25 to the driver circuit 19 by way of the contact pins 20, 21 and the fine wires 26, 27. This received signal is particularly susceptible to electrical and magnetic interference fields.

The distance between the contact pins 20 and 21 is therefore selected to be small, as shown in FIG. 4. The distance between the two contact pins 20, 21 is no more than 5 mm, for example, preferably no more than 3 mm, particularly preferably no more than 1 mm. In this way, an inductance of a coil formed by the contact pins 20, 21, the printed circuit board 16 and the piezoelectric element 25, by way of which coil a magnetic interference field could couple in, is low.

Furthermore, the membrane pot 7 is formed of a metal or provided with a metallic coating and therefore shields the loose fine wires 26 against electrical interference fields. Particularly preferably, the membrane pot 7 is also connected to ground directly or at least not with high impedance, for example with a resistance of 600 ohms to 800 ohms, in any case with a resistance of less than 1000 ohms, in order to be able to deploy this shielding action in the best way possible. For this purpose, a non-depicted line extending in the body 3 can be used, for example, which connects the membrane pot 2 to one of the second contact pins 22-24.

The first contact pins 20, 21 are also comparatively well shielded in their trajectory on the one hand by the membrane pot 7 and on the other hand by the printed circuit board 16.

The inventors have realized, however, that electrical interference fields couple into the signal path from the piezoelectric element 25 as far as the driver circuit 19, in particular at the upwardly protruding upper ends 35 of the first contact pins 20, 21 which have passed through the printed circuit board 16.

Therefore, according to the first exemplary embodiment, a metallic hood 40 is arranged on the printed circuit board 16 in such a way that it, together with the printed circuit board 16, surrounds and shields on all sides the upper ends 35 of the first contact pins 20, 21.

Experiments have shown that, accordingly, interference from the electrical fields shown in FIGS. 3A-3D is significantly reduced. This effect is particularly pronounced in the configurations shown in FIG. 3B and FIG. 3D, in which the electrical interference field acts on the ultrasonic sensor 100, 101 from above.

However, the metallic hood 40 surrounds and shields neither the upper ends 36 of the second contact pins 22-24 nor the components 17, 18 of the driver circuit 19. The majority of the non-depicted conductor tracks on the printed circuit board 16 are also not covered by the metallic hood 40. Accordingly, the metallic hood 40 can advantageously be designed to be small in size and low in weight. The metallic hood 40 can therefore be mounted securely against vibration on the printed circuit board 16 using simple means, in a manner also comparable with other components 17, 18, and contributes hardly any weight increase to the ultrasonic sensor 100 in the process. In particular, with such a small metallic hood 40, especially advantageously it is not necessary to cast the interior 14 of the ultrasonic sensor 100 in order to achieve vibration resistance.

The metallic hood 40 can in particular be produced from a copper or brass sheet. The sheet thickness is preferably designed in such a way that a depth of penetration of an electrical interference field to be expected is substantially fully absorbed into the sheet, but the sheet does not become unnecessarily thick. In the case of the LIN as interference source discussed with reference to FIG. 2, a sheet thickness of 0.3 mm is sufficient. The sheet thickness is preferably at least 0.2 and at most 0.4 mm.

FIG. 6 shows a section A-A in FIG. 1 of an ultrasonic sensor 100 according to a second exemplary embodiment, FIG. 7 shows a section B-B in FIGS. 6 and 8, and FIG. 8 shows a section C-C in FIGS. 6 and 7. Reference is made hereinafter to FIGS. 6 to 8. Features of the second exemplary embodiment, which are comparable to the features of the first exemplary embodiment, will not be described again in detail. The second exemplary embodiment differs from the first exemplary embodiment as follows:

The printed circuit board 16 does not lie flush along its entire circumference against an inner face 37 of the body 3. In a portion on the left in FIGS. 6 and 7, which is arranged opposite the extension portion 6 of the housing 2, a recess 38 is formed in the printed circuit board 16.

The metallic hood 40 is arranged at a border 39 of the printed circuit board 16, which border adjoins the recess 38, and protrudes slightly into the recess 38.

The annular projecting protrusion 15 of the body 3 of the housing 2, on which the printed circuit board 16 is fitted upright, also has a recess 47 in a region of the recess 38 of the printed circuit board 16.

According to the second exemplary embodiment, in a portion arranged above the printed circuit board 16, the metallic hood 40 has a cube or cuboid shape with four vertical walls 41, 42, 43, 44 that extend perpendicular to the printed circuit board and a horizontal wall 45 that extends parallel to the printed circuit board 16 over the ends 35 of the first contact pins 20, 21. In this case, an outer vertical wall 41 is arranged near the border 39 of the printed circuit board 16 over the recess 38. As can be seen in FIG. 7 in particular, a tab 46 formed continuously with the outer vertical wall 41 extends from a lower end of the vertical wall 41 through the recess 38 of the printed circuit board 16 past the border 39 of the printed circuit board 16 and extends downward through the recess 47 in the inwardly projecting protrusion 15 of the housing 2 toward the membrane pot 7. As can be seen in FIGS. 7 and 8, the tab 46 extends parallel to a plane formed by the first contact pins 20, 21. As can be seen in FIG. 8, the tab 46 is only slightly wider than a distance between the first contact pins 20, 21 which for their part extend parallel to one another toward the membrane pot 7. The tab 46 is in particular not wider than and preferably narrower than the outer wall 41, the elongation of which it represents.

According to the second exemplary embodiment, the tab 46 that extends toward the membrane pot 7 can advantageously also be used to shield a vertical portion of the first contact pins 20, 21 between the printed circuit board 16 and the membrane pot 7 against electrical interference field entries, in particular from the left in FIG. 7 (cf. FIG. 3A and FIG. 3C).

As shown in FIG. 7, an inner vertical wall 42, which is arranged opposite the outer vertical wall 41, additionally has a spring pin 48. The spring pin 48 is pressed into a further through-plating 34 of the printed circuit board 16 and is held stably in the through-plating 34 by a spring force (restoring force) of the spring pin 48. The through-plating 34 can have a tin-plated inner surface which is connected to ground. Accordingly, the metallic hood 40 is contacted with the printed circuit board 16 by way of the spring pin 48 of the inner vertical wall 42 and grounded.

FIG. 9 shows a blank 50 according to the second exemplary embodiment. The blank 50 is a form punched out from a copper or brass sheet with a thickness between 0.2 and 0.4 mm, preferably of 0.3 mm. If the blank 49 is folded along the dash-dot-dotted fold lines, for example backwards in the sheet plane, this produces the metallic hood 40 (FIGS. 6-8) with the four vertical walls 41-44, the horizontal wall 45, the tab 46 which continues adjacent to the outer vertical wall 41, and the spring pin 48.

The spring pin 48 is formed in particular as an eyelet 51, for example, which encloses an elongate hole 49. The eyelet has a wall thickness of 0.3 mm, for example, and the elongate hole 49 is a 1-mm bore, for example. If the spring pin 48 is pressed into the through-plating 34 (FIG. 7), the elongate hole 49 is compressed and exerts a restoring force which acts outwardly in the through-plating 34 (FIG. 7) perpendicular to an inner surface of the through-plating 34 (FIG. 7) and fixes the metallic hood 40 (FIG. 7) to the printed circuit board 16 (FIG. 7).

FIG. 10 illustrates a production method for producing the ultrasonic sensor 100 according to a third exemplary embodiment. Reference is also made to FIG. 4 to FIG. 10.

In step S1, the first contact pins 20, 21 and the second contact pins 22-24 are pressed into the body 3 produced from plastics (into the housing 2).

In step S2, the membrane pot 7, on the ultrasound membrane 8 of which the sound transducer element 25 is fitted from the inside, is inserted into an opening 12 of the housing 2. For example, as shown in FIGS. 7 and 8, the membrane pot 7 can be placed on an edge 11 of the body 3 and the retaining ring 4 can be thrown over the membrane pot 7 and the body 3. The retaining ring can then be joined to the membrane pot 7 and the body 3 by means of ultrasonic welding, for example.

In step S3, the first contact pins 20, 21 are contacted with the sound transducer element 25. For this purpose, for example, the first contact pins 20, 21 are soldered to the loose fine wires 26, 27 and the loose fine wires 26, 27 are soldered to the sound transducer element 25.

In step S4, the printed circuit board 16, on which the driver circuit 19 is mounted, is pressed onto the upper ends 35, 36 of the contact pins 20-24 in such a way that the ends 35, 36 pass through the printed circuit board 16.

In step S5, the blank 50 shown in FIG. 9 is punched out from a copper or metal sheet and folded along the dash-dot-dotted fold lines, and thus the metallic hood 40 is obtained.

In step S6, the metallic hood 40 is mounted onto the printed circuit board 16 in such a way that the metallic hood 40 surrounds and shields on all sides the upper ends 35 of the first contact pins 20, 21 passing through the printed circuit board 16. For the mounting, in particular the spring pin 48 is pressed into the through-plating 34 of the printed circuit board 16, for example, with the result that the metallic hood 40 is fixed on the printed circuit board 16, contacted therewith and grounded.

Subsequently, the cover 5 can be placed on the body 3 and joined thereto by means of ultrasonic welding.

An ultrasonic sensor 100 according to the third exemplary embodiment is thus obtained.

An ultrasonic sensor 100 according to exemplary embodiments can therefore in particular be simple to produce, can have a vibration-stable construction with vibration-resistant mounting of the printed circuit board 16 and vibration-resistant fitting of the metallic hood 40, need not require casting of an interior 14 of the plastics housing 2, can be light and break-proof, and, thanks to the first contact pins 20, 21 extending in parallel and the metallic hood 40 shielding at least the ends 35 of the first contact pins 20, 21 passing through the printed circuit board 16, can have excellent EMC interference resistance.

Although the present invention has been described on the basis of exemplary embodiments, it may be modified in diverse ways. Features which have been disclosed for different exemplary embodiments can be combined with one another in any suitable manner, as long as this does not create any contradictions.

The retaining ring 4 is not a necessary feature of the invention, and the membrane pot 7 can also be inserted directly into an opening of the body 3 of the housing 2.

The loose fine wires 26, 27 are not necessary. The contact pins 20, 21 can also be contacted with the piezoelectric element 25 in another way, for example directly.

In the figures, three second contact pins 22-24 are shown, but it is also possible to use only two or more than three second contact pins 22-24 for the external connection.

The metallic hood 40 does not necessarily need to have a cube or cuboid shape with five walls, in particular in the first but also in the second exemplary embodiment. It can also be formed in the shape of a hemisphere, for example.

In the second exemplary embodiment, the tab 46 does not need to extend near to the membrane pot 7, as shown in FIG. 7. To achieve the desired additional shielding effect of the tab 46, it is sufficient if the tab extends at least slightly in the direction of the membrane pot 7 from the lower side of the printed circuit board 16. However, according to an advantageous development, the tab 46 can also extend fully as far as the membrane pot 7 and contact it. In this way, the membrane pot 7 can advantageously be grounded simply by way of the tab 46 of the metallic hood 40.

Only one spring pin 48 fitted to the inner wall 42 has been described. It is understood, however, that a respective spring pin 48 can be formed on one or more of the inner wall 42, the lateral walls 43, 44 and the outer wall 41 and can be pressed into respective through-platings 34 of the printed circuit board 16. If there are a plurality of spring pins 48 present, the metallic hood 40 can be mounted and fixed even more reliably to the printed circuit board 16.

### LIST OF REFERENCE SIGNS

1 motor vehicle
2 housing
3 body
4 retaining ring
5 cover
6 extension portion
7 membrane pot
8 ultrasound membrane
9 side sill
10 rear bumper
11 edge
12 opening in the housing
13 axial direction
14 interior
15 protrusion of the housing
16 printed circuit board
17,18 component
19 driver circuit
20,21 contact pin, first contact pin
22-24 contact pin, second contact pin
25 piezoelectric element, sound transducer element
26,27 loose fine wire
28 lower region
29-34 through-plating
35,36 upper ends
37 body inner face
38 recess of the printed circuit board
39 border of the printed circuit board
40 metallic hood
41 outer vertical wall
42 inner vertical wall
43,44 lateral vertical wall
45 horizontal wall
46 tab
47 recess of the projecting protrusion
48 spring pin
49 elongate hole
50 punched metal sheet, blank
51 eyelet
52 front bumper
100-105 ultrasonic sensor
S1-S6 method steps

1. An ultrasonic sensor for a motor vehicle, having:
a plastics housing,
a membrane pot that is inserted into an opening of the plastics housing and has an ultrasound membrane,
a sound transducer element for inducing and sensing vibration of the ultrasound membrane, which sound transducer element is fitted on the ultrasound membrane from the inside,
a printed circuit board arranged in the interior of the plastics housing, on which printed circuit board a driver circuit for activating the sound transducer element is mounted,
two contact pins for electrically contacting the driver circuit with the sound transducer element, wherein the printed circuit board is pressed onto the contact pins in such a way that ends of the contact pins pass through the printed circuit board, and
a metallic hood which, together with the printed circuit board, surrounds and shields on all sides the ends of the contact pins passing through the printed circuit board.

2. The ultrasonic sensor as claimed in claim 1, wherein the driver circuit comprises one or more electronic components which are mounted outside the metallic hood on the printed circuit board on the same side of the printed circuit board as the metallic hood.

3. The ultrasonic sensor as claimed in claim 2, wherein an interior in the plastics housing is not cast at least on the same side of the printed circuit board as the metallic hood.

4. The ultrasonic sensor as claimed in claim 2, wherein the printed circuit board is fitted upright on a protrusion of the plastics housing.

5. The ultrasonic sensor as claimed in claim 1, wherein the metallic hood has four walls that extend perpendicular to the printed circuit board and a wall that extends parallel to the printed circuit board and over the ends of the contact pins.

6. The ultrasonic sensor as claimed in claim 1, wherein an outer wall of the metallic hood is arranged at a border of the printed circuit board (16) and a tab formed continuously with the outer wall extends past the border (39) of the printed circuit board toward the membrane pot.

7. The ultrasonic sensor as claimed in claim 6, wherein the tab extends parallel to a plane formed by the two contact pins and is as wide as or wider than a distance between the two contact pins.

8. The ultrasonic sensor as claimed in claim 1, wherein the metallic hood is contacted with the printed circuit board and grounded.

9. The ultrasonic sensor as claimed in claim 8, wherein the metallic hood is contacted with the printed circuit board by a spring pin formed continuously with one of four walls of the metallic hood, which spring pin is pressed into a through-plating of the printed circuit board.

10. The ultrasonic sensor as claimed in claim 9, wherein the spring pin is formed as an eyelet that encloses an elongate hole.

11. The ultrasonic sensor as claimed in claim 1, wherein the metallic hood is produced from copper or brass sheet with a sheet thickness between 0.2 and 0.4 mm.

12. The ultrasonic sensor as claimed in claim 11, wherein the metallic hood is punched in one piece from the copper or brass sheet and folded.

13. The ultrasonic sensor as claimed in claim 1, wherein the membrane pot is a metallic membrane pot which is not connected to ground with high impedance.

14. A motor vehicle with the ultrasonic sensor as claimed in claim 1.

15. A method for producing an ultrasonic sensor, including:
pressing two contact pins into a plastics housing;
inserting a membrane pot with an ultrasound membrane and a sound transducer element (25) for inducing and sensing vibration of the ultrasound membrane, which sound transducer element is fitted on the ultrasound membrane from the inside, into an opening of the plastics housing;
contacting the contact pins with the sound transducer element;
pressing a printed circuit board, on which a driver circuit for activating the sound transducer element is mounted, onto ends of the contact pins in such a way that the ends pass through the printed circuit board;
producing a metallic hood by punching out a blank from a copper or metal sheet and folding the blank;
mounting the metallic hood onto the printed circuit board in such a way that the metallic hood, together with the printed circuit board, surrounds and shields on all sides the ends of the contact pins passing through the printed circuit board.
